(19) United States
(12) Patent Application Publication
(10) Pub. No.: US 2008/0168155 A1
(43) Pub. Date: Jul. 10, 2008

(54) Web hard disk server for sharing identical broadcast contents and download method thereof

(76) Inventor: Sang Ki Choi, Goyang-Si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/650,315

(22) Filed: Jan. 5, 2007

(51) Int. Cl. G06F 15/16

(52) U.S. Cl. 709/219

(57) ABSTRACT

The present invention relates to a system and method for a web hard disk server to download broadcast contents from a broadcast content providing server and to store a minimum number of broadcast contents in order to avoid redundancy among downloaded broadcast contents. More specifically, among several individual broadcast contents downloaded or to be downloaded to a web hard disk of the web hard disk server, only one instance of identical broadcast contents is physically stored in a shared manner, so that the capacity of the web hard disk can be efficiently used while users perceive that they use the web hard disk individually.

### BACKGROUND

A variety of useful services are provided to users through networks. Particularly, a web hard disk service allows a user to use a large volume storage system, i.e., a storage space, at a remote site as if it were a hard disk drive in the user's own computer system (personal computer). Many such users at remote sites can upload certain files or data onto the storage space of a web hard disk server, i.e., a web hard disk of the web hard disk server, or update the files or data. In addition, at an arbitrary place, the users can download and use corresponding files or data. In this manner, the service using the web hard disk server allows a user to use the web hard disk of the web hard disk server as if it were a storage device mounted on the user's computer. Folders for respectively storing files categorized into private and public files are formed in the web hard disk. General users authenticated by a corresponding host user are also allowed to freely use the public folder.

However, a conventional method used for private storage is inefficient in that even when a plurality of users store and use identical broadcast contents, the identical broadcast contents are stored in different physical storage spaces of the respective users.

In addition, a conventional method used for public storage is inconvenient in that another user should be informed of a password for connecting to the public folder as well as a domain name (an Internet protocol (IP) address) and identification (ID) for connecting to a website where the web hard disk server is operated. This is because there is a problem of an infringement on copyright or the like if several unspecified individuals share a specific broadcast content without such a login procedure.

Meanwhile, real-time broadcasting, such as digital multimedia broadcasting (DMB) and streaming broadcasting, for communication terminals can be performed through a satellite network, a wired network or a wireless network. In addition to such real-time broadcasting, broadcasting can be accomplished by storing broadcast contents on the web hard disk server in response to a request from a terminal. Such a broadcasting method using a web hard disk server comprises the steps of downloading broadcast contents from a source that provides broadcast contents (hereinafter, referred to as a broadcast content providing server), storing the broadcast contents, and transmitting the broadcast contents to each terminal as needed.

FIG. 1 is a diagram illustrating broadcasting using such a web hard disk server. Referring to FIG. 1, the web hard disk server 110 has a structure in which specific broadcast contents are downloaded from a broadcast content providing server 100 in response to requests from wired/wireless terminals 140 and 150 (e.g., a PC, a cellular phone, or a DMB phone), then stored and transmitted to the wired/wireless terminals 140 and 150, respectively. Accordingly, the web hard disk server 110 should download the broadcast contents requested by the wired/wireless terminals 140 and 150 from the broadcast content providing server 100 and allocate the broadcast contents by unique IDs of the wired/wireless terminals. Here, if a plurality of wired/wireless terminals 140 and 150 request identical broadcast contents, and thus the identical broadcast contents need to be respectively downloaded and stored into the web hard disk server 110, there is a problem with efficiency in that the storage capacity of the web hard disk server 110 is wasted. That is, even though the broadcast contents are identical, the identical broadcast contents are redundantly stored by unique IDs of wired/wireless terminals, and thus, there is a problem in that the storage capacity of the web hard disk server is not efficiently used.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Generally described, the present invention is directed to a system and method for providing a web hard disk server for downloading and efficiently storing broadcast contents in such a manner where, in case of identical broadcast contents, only one of the contents is assigned respectively to unique IDs of terminals but is physically stored and used in a shared manner.

In accordance with an aspect of the present invention, a web hard disk server comprises a web hard disk; and an index storage unit having indexes, unique numbers of broadcast contents stored in the web hard disk, assigned by unique IDs of respective wired/wireless terminals that have requested transmission of corresponding broadcast contents, wherein if the broadcast contents to be downloaded from a broadcast content providing server are identical, only one of the broadcast contents is stored without individually storing the downloaded broadcast contents.

The web hard disk server may further comprise an input unit for interfacing with an administrator of the web hard disk server, a display unit for displaying a list of stored broadcast contents, the total capacity of the web hard disk, the used capacity of the web hard disk, and a management menu in the web hard disk server; a router for serving as a connection gate of a plurality of web hard disks, if present; and a network connection unit for providing a network connection protocol.

In accordance with another aspect of the present invention, a method is provided for sharing identical broadcast contents when the web hard disk server downloads broadcast contents from a broadcast content providing server for providing broadcast contents. The method comprises the steps of entering a download mode in which the web hard disk server is connected to the broadcast content providing server through a network so that a specific broadcast content in the broadcast content providing server is downloaded, storing the broadcast content received from the broadcast content providing server into a temporary buffer, and determining through comparison whether broadcast content identical to the broadcast content stored in the temporary buffer exists in the web hard disk. If an identical broadcast content exists, an index of the broadcast content existing in the web hard disk is assigned to a unique ID of a wired/wireless terminal that has requested the corresponding broadcast content, without performing a process of storing the broadcast content stored in the temporary buffer into the web hard disk. If an identical broadcast content does not exist, the broadcast content stored in the temporary buffer is stored in the web hard disk, and an index of the broadcast content stored in the web hard disk is assigned to the unique ID of the wired/wireless terminal that has requested the corresponding broadcast content; and deleting the broadcast content stored in the temporary buffer.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a diagram illustrating a conventional broadcast content reproduction system using a wired/wireless network;

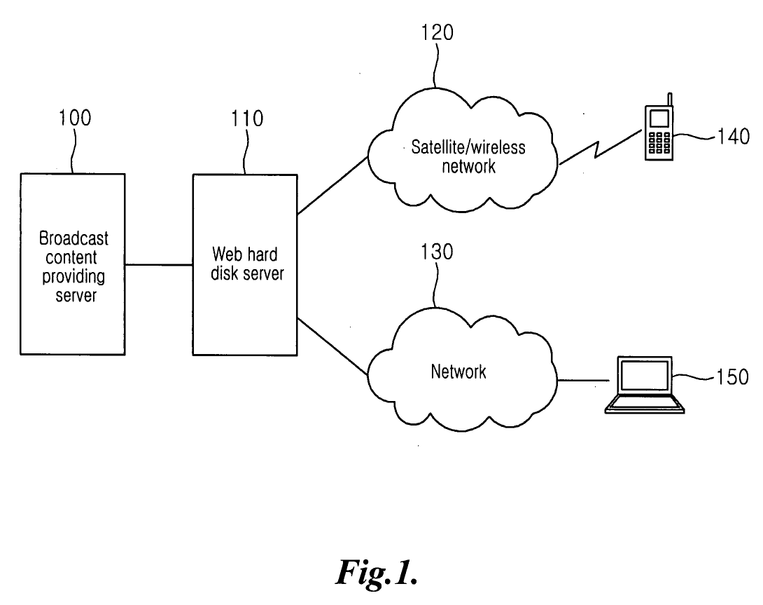

FIG. 2 is a pictorial diagram depicting a state where a web hard disk server is connected to wired/wireless terminals;

FIG. 3 is a block diagram showing the inner configuration of the web hard disk server;

FIG. 4 is a pictorial diagram depicting a state where broadcast content indexes are allocated to respective users;

FIG. 5A is an exemplary view showing a screen of a first wired/wireless terminal;

FIG. 5B is an exemplary view showing a screen of a second wired/wireless terminal;

FIG. 6 is an exemplary view showing a screen of the web hard disk server; and

FIG. 7 is a flowchart illustrating a process of downloading broadcast contents according to the present invention.

### DETAILED DESCRIPTION

Hereinafter, preferred embodiments of the present invention will be described in greater detail with reference to the accompanying drawings. It should be noted that when elements are designated by reference numerals throughout the drawings, like elements are designated by like reference numerals even though they are shown in different figures of the drawings. Further, if it is determined that specific descriptions of known related functions or constitutions may unnecessarily make the subject matter of the present invention obscure in the description of the present invention, detailed descriptions thereof will be omitted. In addition, the terms used hereinafter are terms defined in consideration of their functions in the present invention and may be changed according to general practices of those skilled in the art. The definitions should be made based on the overall disclosure herein.

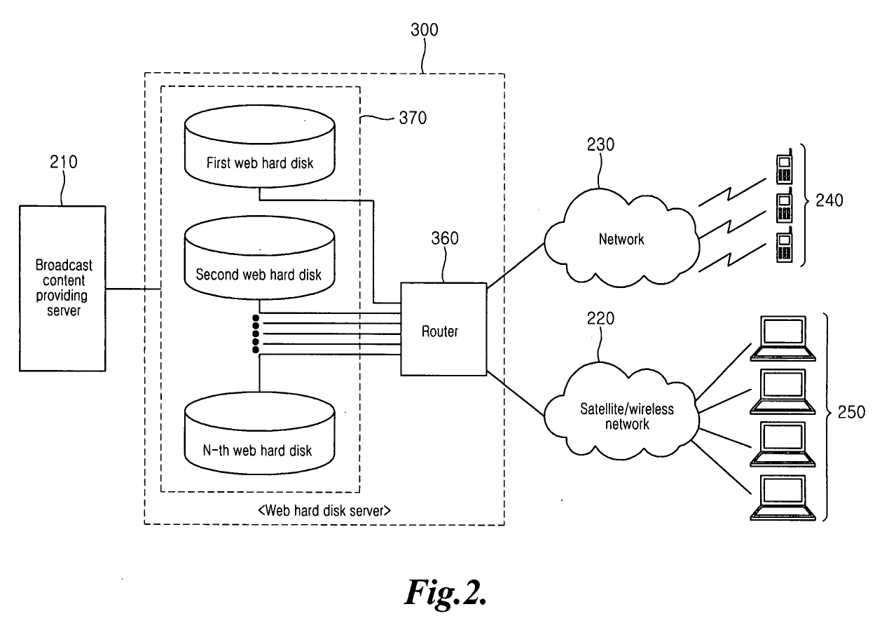

FIG. 2 is a pictorial diagram showing a configuration including a broadcast content providing server, a web hard disk server, a router, networks, and wired/wireless terminals according to the present invention.

A broadcast content providing server 210 contains a plurality of broadcast contents and performs the function of allowing specific broadcast contents to be downloaded into a web hard disk server 300 in response to requests from the wired/wireless terminals 240 and 250. The broadcast contents may be any type of data files, including, but not limited to, movies, dramas, animations, and music videos files. More particularly, the broadcast contents may be files respectively containing moving pictures (including photographs and flashes), audios (including music and bell sounds) and text (including E-mails, E-cards, and text messages), and files containing combinations thereof.

The web hard disk server 300 is connected to the wired/wireless terminals 240 and 250 through a network 220 or a satellite/wireless network 230 and performs the functions of downloading broadcast contents requested by the wired/wireless terminals 240 and 250 from the broadcast content providing server 210 and storing the downloaded broadcast contents into web hard disks 370. The stored broadcast contents are transmitted to the corresponding wired/wireless terminals 240 and 250 through the network 220 or the satellite/wireless network 230 in response to requests from the wired/wireless terminals 240 and 250. Accordingly, the wired/wireless terminals 240 and 250 receive the broadcast contents stored in the web hard disk 370 and then play back the received broadcast contents.

The web hard disk server 300 has a plurality of web hard disks 370, and the web hard disks 370 function as memory in which the broadcast contents are substantially stored. The plurality of web hard disks 370 are connected to one another through internal buses. Further, web hard disks physically remote from one another may be connected to one another through a router 360. Although FIG. 2 shows the web hard disk server 300 as if the web hard disks 370 are located in the same server space, it will be apparent that web hard disks included in different web hard disk servers may be connected to one another through the router 360.

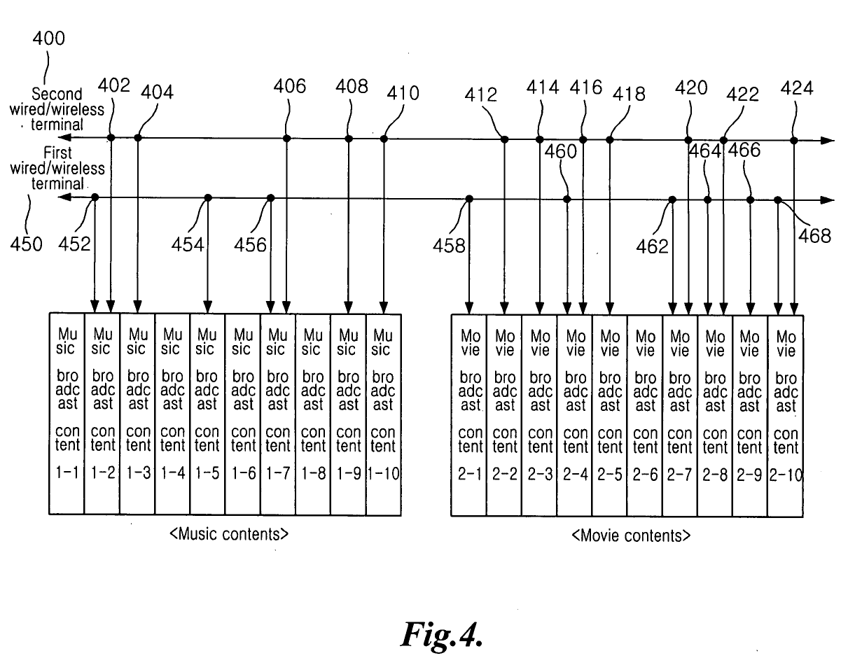

Further, it is to be understood that although the broadcast contents stored in the web hard disks 370 take the logical form of individual storage for respective wired/wireless terminals, identical broadcast contents among them are physically stored in a shared manner. That is, broadcast contents downloaded from the broadcast content providing server 210 appear to be stored by the unique IDs of the wired/wireless terminals 240 and 250. However, in fact, identical broadcast contents among the broadcast contents downloaded from the broadcast content providing server 210 are not separately stored for the respective unique IDs and only one copy of the broadcast content is stored into the web hard disk. Only the index value of the stored identical broadcast content is assigned to the unique IDs of the respective wired/wireless terminals. The identical broadcast content stored in this manner has the characteristic of a private web hard disk in which it is individually downloaded to a corresponding wired/wireless terminal whenever the wired/wireless terminal requests the broadcast content. The operation of such a web hard disk will be described in greater detail with reference to FIGS. 4, 5A, 5B, 6, and 7.

The wired/wireless terminals 240 and 250 perform the functions of downloading broadcast contents from the web hard disk server 300 through the network 220 or the satellite/wireless network 230, and playing back the broadcast contents. The wired/wireless terminals 240 and 250 download specific broadcast contents stored in the web hard disk server 300. To this end, each of the wired/wireless terminals 240 and 250 is assigned a unique ID (a unique IP address or a unique serial number) and downloads its own broadcast content designated by a corresponding unique ID. The wired/wireless terminals 240 and 250 are terminals, such as personal computers, cellular phones, or DMB phones, connectible to a wired/wireless network, and it will be apparent that the terminals are not limited to specific types.

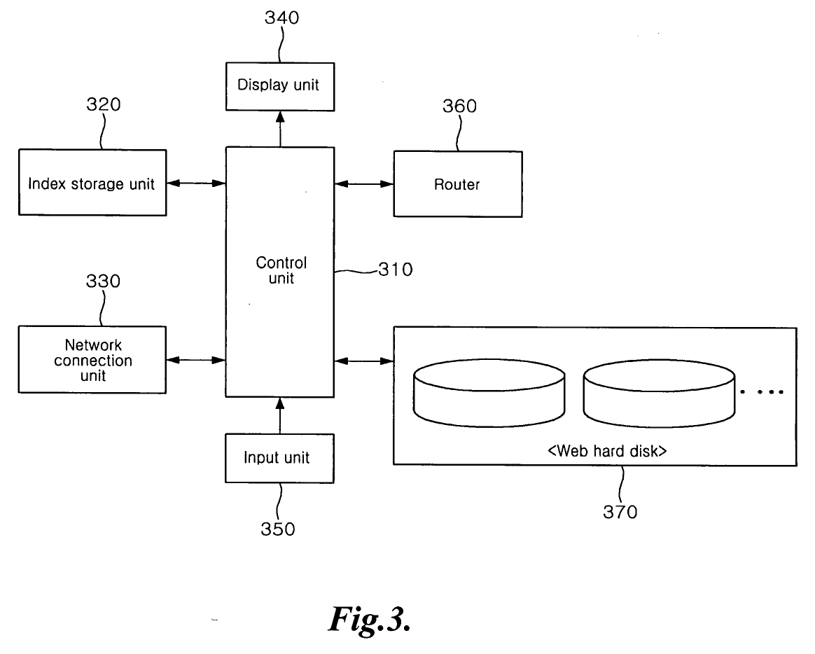

Meanwhile, in the web hard disk server 300 of FIG. 2, only the web hard disk 370 and the router 360 are shown while other functional blocks are omitted in order to clarify the distinctive features of the present invention. FIG. 3 shows detailed configuration blocks of the web hard disk server 300, which will be described below.

FIG. 3 is a block diagram showing the inner configuration of the web hard disk server 300 according to the present invention.

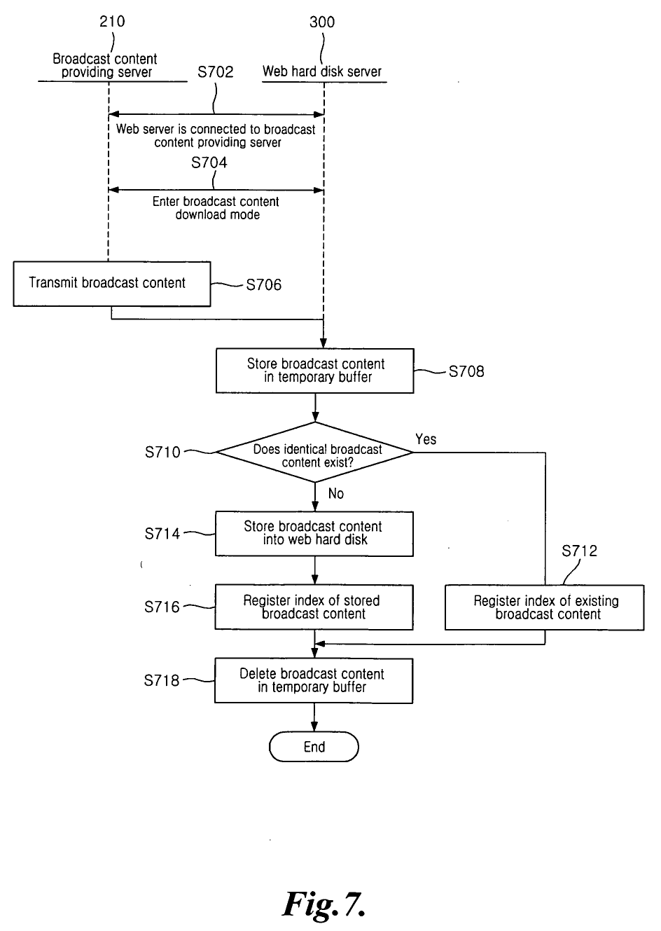

A display unit 340 performs the function of managing the use status of a user who uses the web hard disk server 300, or displaying the use state of the web hard disk. An administrator of the web hard disk server manages the web hard disk server while checking various kinds of numerical values displayed on the display unit 340. The process of displaying content on the display unit 340 is shown in FIG. 7, and an embodiment of the display unit will be described below with reference to FIG. 7.

The input unit 350 is a user interface comprising a variety of numeric and functional keys. The administrator of the web hard disk server 300 performs a variety of functions of the web hard disk server through the input unit 350, and controls and manages the web hard disk server through the input unit.

The web hard disk 370 comprises a plurality of hard disks for storing broadcast contents uploaded from the wired/wireless terminals. The web hard disk 370 is connected to a plurality of other web hard disks through internal buses. In addition, the web hard disk is connected through the router 360 to other web hard disks physically spaced apart from one another. In the present invention, as described above, although the broadcast contents stored in the web hard disk 370 logically take the form of individual storage for each user, the broadcast contents are physically stored in a shared manner.

The network connection unit 330 is a functional unit for providing a connection protocol for allowing the web hard disk server 300 to be connected to a network, and it will be apparent that the connection protocol includes, but is not limited to, TCP/IP, UDP/IP and the like.

The control unit 310 controls the functional blocks to store the broadcast contents downloaded from the broadcast content providing server 210 into the web hard disk.

An index storage unit 320 functions to assign respective users indexes (e.g., unique numbers or addresses) of the broadcast contents to be stored in the web hard disk 370. For example, Table 1 below will be referred to by way of example.

TABLE 1

| | Indexes of broadcast contents |
|---|---|
| Wired/wireless terminal | stored in web hard disk |
| First wired/wireless terminal | 1-2, 1-5, 1-7 |
| Second wired/wireless terminal | 1-2, 1-3, 1-7, 1-9, 1-10 |
| . . . | . . . |
| . . . | . . . |
| . . . | . . . |

As shown in Table 1, the first wired/wireless terminal stores and uses broadcast contents having indexes (unique numbers) of 1-2, 1-5, and 1-7 in the web hard disk, and the second wired/wireless terminal stores and uses broadcast contents having indexes of 1-2, 1-3, 1-7, 1-9, and 1-10 in the web hard disk. It can be understood that although each of the wired/wireless terminals accesses the broadcast contents through the web hard disks, the broadcast contents having indexes of 1-2 and 1-7 are shared and used by both the first and second terminals as shown in Table 1. Thus “sharing” refers only to physical sharing, and does not mean logical sharing. That is, even though physical sharing is achieved for the broadcast contents having the indexes 1-2 and 1-7, each is stored as an identical broadcast content in a specific web hard disk, the first and second wired/wireless terminals having logical individual properties, in practice meaning that they individually use the broadcast contents.

FIG. 4 is a pictorial diagram showing an example of logical and physical connection relationships between broadcast contents stored in the web hard disk server and individual wired/wireless terminals as shown in Table 1.

For the sake of convenience of explanation, as shown in FIG. 4, it is assumed that music broadcast contents stored in the web hard disk include ten music broadcast contents in total, from broadcast content 1-1 to broadcast content 1-10, and movie broadcast contents stored in the web hard disk include ten movie broadcast contents in total, from broadcast content 2-1 to broadcast content 2-10. Assuming that ten music broadcast contents and ten movie broadcast contents are stored in the web hard disk as described above, it is understood that, among the total twenty broadcast contents, the first wired/wireless terminal 450 downloads and uses music broadcast contents 1-2, 1-5, and 1-7 (452, 454, and 456) and movie broadcast contents 2-1, 2-4, 2-7, 2-8, 2-9, and 2-10 (458, 460, 462, 464, 466, and 468), while the second wired/wireless terminal 400 downloads and uses music broadcast contents 1-2, 1-3, 1-7, 1-9, and 1-10 (402, 404, 406, 408, and 410) and movie broadcast contents 2-2, 2-3, 2-4, 2-5, 2-7, 2-8, and 2-10 (412, 414, 416, 418, 420, 422, and 424).

Accordingly, it is understood that the first wired/wireless terminal 450 and the second wired/wireless terminal 400 share music broadcast contents 1-2 and 1-7, and movie broadcast contents 2-4, 2-7, 2-8, and 2-10. The sharing does not mean downloading the files through complete sharing. It merely means that the first wired/wireless terminal 450 and the second wired/wireless terminal 400 do not separately manage the broadcast contents in the web hard disk but use only a single broadcast content in a shared manner. That is, if broadcast contents to be stored in the web hard disk by request of both the first and second wired/wireless terminals 450 and 400 are identical, they are not redundantly stored in the web hard disk and only a single broadcast content that has been downloaded once is registered and stored. The stored broadcast content is matched to each of individual user areas as shown in Table 1 and FIG. 4 so that each user can logically use the web hard disk, thereby allowing the user to individually use the broadcast content as his/her own content. A method of downloading a broadcast content from the broadcast content providing server to the web hard disk server will be described below with reference to the flowchart of FIG. 7.

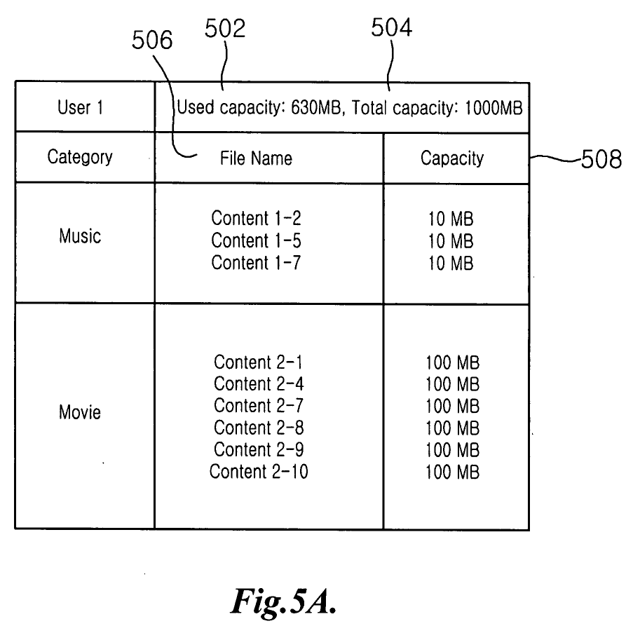

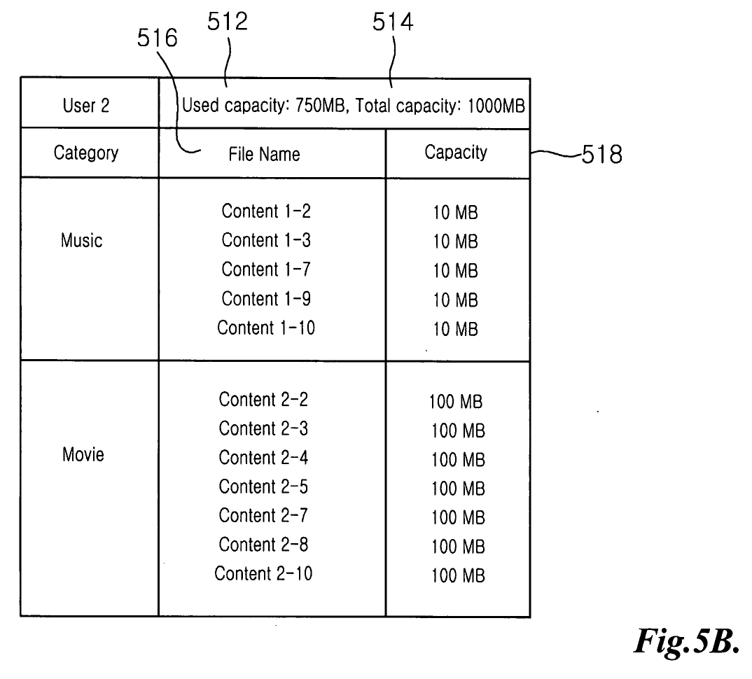

FIGS. 5A and 5B are views showing screens of respective wired/wireless terminals.

FIG. 5A is an exemplary view showing the screen of a first wired/wireless terminal when the first wired/wireless terminal is connected to a web hard disk, and FIG. 5B is an exemplary view showing the screen of a second wired/wireless terminal when the second wired/wireless terminal is connected to the web hard disk. On the screens of the first and second wired/wireless terminals, used capacities of the web hard disk 502 and 512 associated with the respective wired/wireless terminals are displayed, together with the user's selection of broadcast contents 506 and 516 currently stored in the web hard disk, the sizes of the broadcast contents 508 and 518, and available total capacities of the web hard disk 504 and 514. Referring to FIGS. 5A and 5B, it is understood that only the types of stored broadcast contents are different according to the respective users.

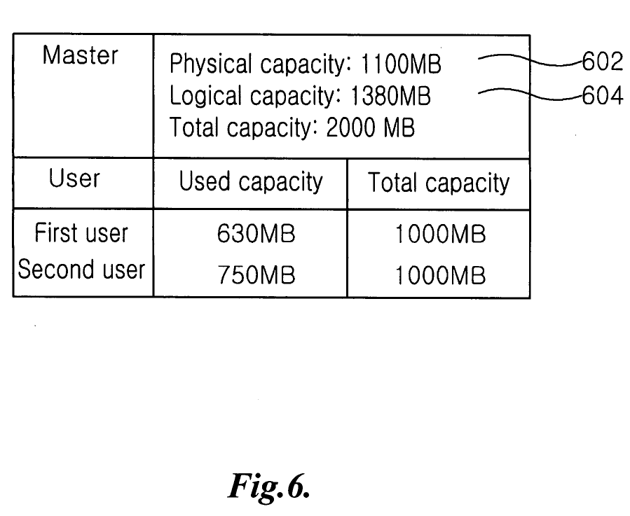

FIG. 6 is a view showing an example of a screen of a display unit of the web hard disk server.

Although the web hard disk basically employs an individual storage scheme, it has a structure in which, for identical broadcast contents, only one instance is stored so that the broadcast content can be physically shared. For example, if it is assumed that ten music broadcast contents (each of which is 10 MB in size, for a total size of 100 MB) are stored in the web hard disk, and ten movie broadcast contents (each of which is 100 MB in size, for a total of 1,000 MB) are stored in the web hard disk, a total of 1,100 MB (100 MB+1,000 MB) are used in the web hard disk to store these twenty broadcast contents.

However, if the concept of storing identical broadcast contents in a shared manner and using the shared broadcast contents according to the present invention is employed, a total capacity that externally appears to be the sum of capacities individually used by respective wired/wireless terminals may seem to be larger than the physically used capacity of 1,100 MB.

For example, if the first wired/wireless terminal receives and uses three music broadcast contents (3×10 MB=30 MB) and six movie broadcast contents (6×100 MB=600 MB) among the stored ten music broadcast contents and ten movie broadcast contents, for a total of 630 MB (30 MB+600 MB), the capacity of the web hard disk externally appears to be used. If the second wired/wireless terminal receives and uses five music broadcast contents (5×10 MB=50 MB) and seven movie broadcast contents (7×100 MB=700 MB), for a total of 750 MB (50 MB+700 MB), the capacity of the web hard disk externally appears to be used.

Accordingly, although the physically used capacity of the web hard disk, which is actually used by the two first and second wired/wireless terminals, is merely 1,100 MB 602, the two wired/wireless terminals appear to use 630 MB and 750 MB capacities of the web hard disk, respectively, so that they may seem to use a capacity of 1,380 MB (630 MB+750 MB) 604 in total.

FIG. 7 is a flowchart illustrating a process of downloading broadcast contents stored in a broadcast content providing server to a web hard disk server according to the present invention.

First, the web hard disk server 300 is connected to the broadcast content providing server (S702). The connection may be established in response to a request from a wired/wireless terminal or by an administrator of the web hard disk server. If the connection is successfully established, an entry into a broadcast content download mode is made, wherein a specific broadcast content stored in the broadcast content providing server is downloaded into the web hard disk server (S704). Entry into the download mode is made when the web hard disk server requests to download a specific broadcast content from the broadcast content providing server and the request is then approved.

When the entry into the broadcast content download mode has been successfully made (S704), the broadcast content providing server transmits the specific broadcast content to be downloaded to the web hard disk server 300 (S706). The web hard disk server 300 stores the received broadcast content in a temporary buffer (S708). Next, the web hard disk server searches its own web hard disk and determines whether a broadcast content identical with the broadcast content stored in the temporary buffer already exists in the web hard disk (S710).

The determination of whether the identical broadcast content exists (S710) may be performed in various manners. An index included in first header information of a broadcast content may be analyzed to determine whether the index of the broadcast content is identical; substantial data frames of a broadcast content may be compared one by one to determine whether data are identical; or the contents of a broadcast content are compared at regular intervals (e.g., every ten frames, in the case of a moving picture), instead of comparison of all data of the broadcast content, in order to reduce the time taken for comparison and determination. There is no limitation on such a determination method.

If it is determined that an identical broadcast content does not exist in the web hard disk, the broadcast content in the temporary buffer is stored into the web hard disk (S714). An index of the broadcast content stored in the web hard disk is registered in an index storage unit as information on the broadcast content to be used by the user (S716), and the broadcast content stored in the temporary buffer is deleted (S718). On the other hand, if an identical broadcast content exists, an index of the identical broadcast content that has been previously stored in the web hard disk and has been located is registered in the index storage unit as information on the broadcast content to be used by the user (S712), and the broadcast content stored in the temporary buffer is deleted (S718).

Meanwhile, the web hard disk server 300 downloads the broadcast content requested by the wired/wireless terminal (240 or 250) and stores the broadcast content in the temporary buffer in steps S706 and S708, determines whether an identical broadcast content exists in the web hard disk server in step S710, and, if an identical broadcast content exists in the web hard disk server, registers the index of the existing broadcast content, instead of the index of the broadcast content stored in the temporary buffer, in step S712.

However, in another embodiment of the present invention, before downloading the broadcast content requested by the wired/wireless terminal into the temporary buffer, the web hard disk server determines in advance whether a broadcast content identical to the broadcast content requested by the wired/wireless terminal exists in the web hard disk. If the identical broadcast content exists, the transmission of the broadcast content in step S706 and the storage of the broadcast content in the temporary buffer in step 708 may not be performed.

Further, in another embodiment of the present invention, if a plurality of wired/wireless terminals request downloading identical broadcast contents, only one broadcast content is downloaded once. For example, in a case where a first wired/wireless terminal reserves downloading a first broadcast content that will be broadcast at 23:00, the control unit stores a unique ID or the like of the broadcast content to set up a download reservation. Then, if the second wired/wireless terminal also requests a reservation for downloading the first broadcast content that will be broadcasted at 23:00, the web hard disk server searches a list of broadcast contents that have been previously reserved to be downloaded, detects that an identical broadcast content is reserved to be downloaded, and downloads the first broadcast content only once. Next, the index of the downloaded first broadcast content is assigned and registered to IDs of both the first and second wired/wireless terminals that have reserved downloading the first broadcast content.

As described above, among a plurality of individual broadcast contents to be downloaded from the broadcast content providing server to the web hard disk, only one of identical broadcast contents is physically stored in a shared manner, so that the capacity of the web hard disk can be efficiently used while users use the web hard disk individually.

Although the present invention has been described above in connection with the specific embodiments such as a web hard disk server, various modifications and changes can be made thereto without departing from the scope of the present invention. Therefore, it will be apparent that the scope of the present invention is not defined by the aforementioned embodiments but by the appended claims and equivalents thereof.

While illustrative embodiments have been illustrated and described, it will be appreciated that various changes can be made therein without departing from the spirit and scope of the invention.

The embodiments of the invention in which an exclusive property or privilege is claimed are defined as follows:

1. A web hard disk server for sharing identical broadcast contents, the web hard disk server downloading broadcast contents from a broadcast content providing server for providing broadcast contents and transmitting the downloaded broadcast contents to wired/wireless terminals, the web hard disk server comprising:
a web hard disk; and
an index storage unit having indexes assigned by unique IDs of respective wired/wireless terminals that have requested transmission of corresponding broadcast contents, the indexes being unique numbers of broadcast contents stored in the web hard disk,
wherein if the broadcast contents to be downloaded from the broadcast content providing server are identical, only one instance of the broadcast contents is stored, without individually storing the downloaded broadcast contents.

2. The web hard disk server as claimed in claim 1, wherein a plurality of web hard disks exist in the web hard disk server and are connected to one another through buses.

3. The web hard disk server as claimed in claim 1, further comprising:
an input unit for interfacing with an administrator of the web hard disk server;
a display unit for displaying a list of stored broadcast contents, the total capacity of the web hard disk, the used capacity of the web hard disk, and a management menu in the web hard disk server;
a router for serving as a connection gate of a plurality of web hard disks, if present; and
a network connection unit for providing a network connection protocol.

4. A download method of a web hard disk server for sharing identical broadcast contents, the web hard disk server downloading broadcast contents from a broadcast content providing server for providing broadcast contents, the method comprising the steps of:
entering a download mode in which the web hard disk server is connected to the broadcast content providing server through a network so that a specific broadcast content in the broadcast content providing server is downloaded;
storing the broadcast content received from the broadcast content providing server into a temporary buffer, and determining through comparison whether a broadcast content identical with the broadcast content stored in the temporary buffer exists in the web hard disk;
if an identical broadcast content exists, assigning an index of the broadcast content existing in the web hard disk to a unique ID of a wired/wireless terminal that has requested the corresponding broadcast content, without performing a process of storing the broadcast content stored in the temporary buffer into the web hard disk;
if an identical broadcast content does not exist, storing the broadcast content stored in the temporary buffer into the web hard disk, and assigning an index of the broadcast content stored in the web hard disk to the unique ID of the wired/wireless terminal that has requested the corresponding broadcast content; and
deleting the broadcast content stored in the temporary buffer.

5. The method as claimed in claim 4, wherein the step of determining through comparison whether a broadcast content identical with the broadcast content stored in the temporary buffer exists in the web hard disk comprises comparing indexes in the header information of broadcast contents with each other.

6. The method as claimed in claim 4, wherein the step of determining through comparison whether a broadcast content identical with the broadcast content stored in the temporary buffer exists in the web hard disk comprises comparing the contents of the broadcast contents with each other at regular intervals to reduce comparison time.

7. A download method of a web hard disk server for sharing identical broadcast contents, the web hard disk server downloading broadcast contents from a broadcast content providing server for providing broadcast contents, the method comprising the steps of:
requesting a download reservation of a broadcast content, to the web hard disk server by a wired/wireless terminal;
searching a list containing broadcast contents that have been previously reserved to be downloaded;
if the search shows that the broadcast content to which the download reservation is made is identical with a broadcast content contained in the list, downloading the corresponding broadcast content only once without additionally setting up a download reservation; and
assigning index information of the downloaded broadcast content to a plurality of wired/wireless terminals that have requested download reservations of the same corresponding broadcast content.
